(19) United States
(12) Patent Application Publication
(10) Pub. No.: US 2026/0244078 A1
(43) Pub. Date: Aug. 20, 2026

(54) ACTUATOR ASSEMBLY

(71) Applicant: CAMBRIDGE MECHATRONICS LIMITED, Cambridge (GB)

(72) Inventors: Samuel Armstrong, Cambridge (GB); Stephen Matthew Bunting, Cambridge (GB); James Darby, Cambridge (GB); Robin Eddington, Cambridge (GB); Alexander Johnson, Cambridge (GB); Reto Klopfenstein, Cambridge (GB); Emily Kwok, Cambridge (GB); Robert Langhorne, Cambridge (GB)

(21) Appl. No.: 19/471,098

(22) PCT Filed: Apr. 2, 2024
(86) PCT No.: PCT/GB2024/050903

§ 371 Date: Sep. 30, 2025

(30) Foreign Application Priority Data
Mar. 30, 2023 (GB) 2304717.8

(51) Int. Cl. G03B 5/04; H04N 23/55; H04N 23/68

(52) U.S. Cl. CPC G03B 5/04; G03B 2205/0015; H04N 23/55; H04N 23/687

(57) ABSTRACT

An actuator assembly (2) comprising: a first part (10); a second part (20) that is movable relative to the first part; and one or more actuating units (30) each configured, on actuation, to apply a respective actuating force (F) to the second part capable of moving the second part relative to the first part, and wherein each actuating unit comprises: a body portion (31) arranged, upon actuation of the one or more actuating units, to move along a path in an actuating plane within a range of expected movement; a force-modifying flexure (32) connected between the body portion and the first part; an SMA element (34) connected between the body portion and the first part, wherein the SMA element is arranged, on actuation, to apply an input force (Fi) to the body portion capable of deforming the force-modifying flexure such that the actuating force is applied to the second part; further comprising at least one endstop (50) between each actuating unit and the first part, wherein the at least one endstop is configured to engage upon movement of the body portion in the actuating plane beyond the range of expected movement.

### FIELD

The present application relates to an actuator assembly, in particular to an actuator assembly comprising an actuating unit for driving movement of the movable part relative to a support structure. The actuating unit comprises an SMA element that actuates the actuating unit.

### BACKGROUND

SMA actuator assemblies may be used in a variety of applications for effecting movement of a movable part relative to a support structure.

For example, WO 2013/175197 A1 describes a camera apparatus in which SMA actuator wires are arranged to move a lens element relative to an image sensor in a plane that is perpendicular to the optical axis of the lens element, thereby effecting optical image stabilization (OIS). WO 2010/029316 A1 discloses an SMA actuation apparatus in which SMA actuator wires are used to provide OIS in a camera by driving tilting of a camera unit including a camera lens element and an image sensor. WO 2011/104518 A1 describes an actuator assembly comprising eight SMA actuator wires capable of effecting positional control of a movable element with multiple degrees of freedom.

Typically, the movement range of the movable part in such SMA actuator assemblies is limited by the maximum extent of contraction in the SMA wires, and the actuating force acting on the movable part is limited by the input force achievable by the SMA wires. To increase the maximum stroke or the actuating force, longer or thicker SMA actuator wires may be used at the expense of increased cost and size and/or reduced response time of the actuator assembly. This may not be practical in miniature applications.

WO 2022/084699 A1 discloses an actuator assembly comprising an actuating unit (incorporating an SMA wire) that, on actuation, moves a movable part relative to the support structure. The actuating unit may be designed to amplify the movement range of the movable part, to amplify the actuating force acting on the movable part, or to re-direct the force applied by the SMA wire.

It is an object of the present invention to provide an improved actuator assembly comprising an actuating unit.

### SUMMARY

According to an aspect of the present invention, there is provided an actuator assembly comprising: a first part; a second part that is movable relative to the first part; and one or more actuating units each configured, on actuation, to apply a respective actuating force to the second part capable of moving the second part relative to the first part, and wherein each actuating unit comprises: a body portion arranged, upon actuation of the one or more actuating units, to move along a path in an actuating plane within a range of expected movement; a force-modifying flexure connected between the body portion and the first part; an SMA element connected between the body portion and the first part, wherein the SMA element is arranged, on actuation, to apply an input force to the body portion capable of deforming the force-modifying flexure such that the actuating force is applied to the second part; further comprising at least one endstop between each actuating unit and the first part, wherein the at least one endstop is configured to engage upon movement of the body portion in the actuating plane beyond the range of expected movement.

Further aspects of the present invention are set out in the dependent claims, and in the detailed description below.

### BRIEF DESCRIPTION OF THE DRAWINGS

Certain embodiments of the present invention will now be described, by way of example only, with reference to the accompanying drawings in which:

FIG. 1 is a schematic view of a camera apparatus incorporating an actuator assembly;

FIGS. 2A and 2B are perspective and plan views of an actuating unit forming part of the actuator assembly;

FIG. 3 is a schematic plan view of an arrangement of four actuating units;

FIGS. 4a and 4b schematically show an actuating unit incorporating an endstop;

FIGS. 5a and 5b schematically show further actuating units incorporating an endstop;

FIGS. 6a and 6b show a further actuating unit incorporating an endstop; and

### DETAILED DESCRIPTION

### Camera Apparatus

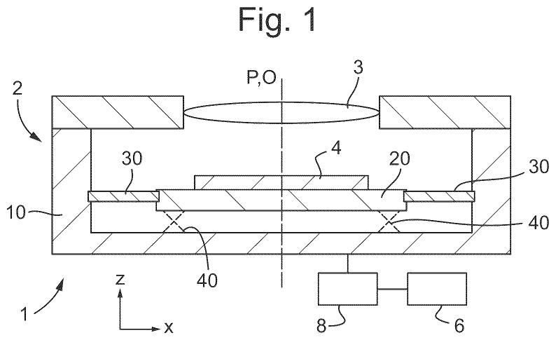

FIG. 1 schematically shows an apparatus 1 incorporating an actuator assembly 2 in accordance with an embodiment of the present invention. The apparatus 1 is, for example, a camera apparatus 1. The apparatus 1 is to be incorporated in a portable electronic device such as a mobile telephone, or tablet computer. Thus, miniaturisation is an important design criterion.

The apparatus 1 comprises an actuator assembly 2 or may itself be considered an example of an actuator assembly 2. The actuator assembly 2 comprises a support structure 10 (an example of a first part 10) and a movable part 20 (an example of a second part 20). The movable part 20 is supported on the support structure 10. The movable part 20 is movable relative to the support structure 10. The actuator assembly 2 comprises one or more actuating units 30 that, on selective actuation, drive movement of the movable part 20 relative to the support structure 10.

The movable part 20 may be supported (so suspended) on the support structure 10 exclusively by the actuating units 30. However, preferably, the actuator assembly 2 comprises a bearing arrangement 40 that supports the movable part 20 on the support structure 10. The bearing arrangement 40 may have any suitable form for allowing movement of the movable part 20 with respect to the support structure 10, in particular in one or more degrees of freedom of movement (DOFs). The bearing arrangement 40 may constrain (i.e. reduce or even prevent) movement of the movable part 20 relative to the support structure 10 in other DOFs. For this purpose, the bearing arrangement 40 may, for example, comprise a rolling bearing (such as a roller bearing or ball bearing), a flexure bearing (i.e. an arrangement of flexures or other resilient elements guiding movement), or a plain bearing or sliding bearing.

The actuator assembly 2 (optionally the support structure 10) defines a primary axis P. In some embodiments, the actuator assembly 2 (optionally the support structure 10) extends primarily in a direction orthogonal to a primary axis P. The extent of the actuator assembly 2 along the primary axis is less than the extent of the actuator assembly 2 along axes orthogonal to the primary axis P. Alternatively or additionally, the support structure 10 and/or movable part 20 may comprise a plate or major surface that extends orthogonally to the primary axis P. Alternatively or additionally, in embodiments in which the actuator assembly 2 or apparatus 1 comprises an optical element (such as lens 3) or imaging element (such as imager sensor 4, having a photosensitive array extending orthogonally to an imaging axis), the primary axis P may coincide with the optical axis O of the optical element or imaging axis of the imaging element when the movable part 20 is in a central position or orientation.

In general, the movable part 20 may be movable relative to the support structure 10 in up to six degrees of freedom (DOFs). In the context of describing the DOFs of movement, the primary axis P may also be referred to as the z axis, and the axes that are perpendicular to the primary axis P (and to each other) may be referred to as the x and y axes. The x and y axes span the x-y plane. The movable part 20 may be movable relative to the support structure 10 in all or in any subset (including in only one) of the following DOFs:
Tx and Ty movement: Translational movement in a plane (i.e. the x-y plane) that is orthogonal to the primary axis P. So, the movable part 20 may be independently movable along two orthogonal axes (along the x and y axes). The movable part 20 may be movable to any translational position in the plane within a range of movement. Even though movement along the x and y axes are grouped here, the movable part 20 may in general be movable along only one axis that is orthogonal to the primary axis P (i.e. about only one of the x and y axes), optionally in combination with some of the other DOFs described herein.
Rx and Ry movement: Rotational movement (or simply rotation or tilting) about two orthogonal axes (i.e. about the x and y axes) that are perpendicular to the primary axis P. The movable part 20 may be rotatable to any rotational position (i.e. to any orientation) within a range of movement. Even though rotation about the x and y axes is described in combination here, the movable part 20 may in general be rotatable about only one axis that is orthogonal to the primary axis P (i.e. about only one of the x and y axes), optionally in combination with of the other DOFs described herein.
Tz movement: Translational movement along the primary axis P (i.e. along the z axis). The movable part 20 may be movable to any translational position along the primary axis P within a range of movement.
Rz movement: Rotational movement (or simply rotation) about the primary axis (i.e. about the z axis). The movable part 20 may be rotatable to any rotational position (i.e. to any orientation) within a range of movement.

In some specific embodiments, the movable part 20 may be supported in a manner allowing movement of the movable part 20 relative to the support structure 10 in a plane (also referred to as a movement plane) orthogonal to a primary axis P. The bearing arrangement 40 may allow movement in the plane. The movable part 20 may move translationally in the plane (Tx, Ty movement) and optionally rotationally in the plane (Rz movement). Movement along the primary axis P and rotation about the axes orthogonal to the primary axis P (so Tz, Rx and Ry movement) may be constrained or prevented. Examples of actuator assemblies in which such planar movement is allowed are disclosed in WO 2013/175197 A1 and WO 2017/072525 A1, each of which is herein incorporated by reference.

In some other specific embodiments, the movable part 20 may be supported in a manner allowing tilting of the movable part 20 relative to the support structure 10 about any axis orthogonal to the primary axis P. The bearing arrangement 40 may allow such tilting. The movable part 20 may rotate or tilt about two orthogonal axes that are perpendicular to the primary axis P. Optionally, the movable part 20 may additionally rotate about the primary axis. So, Rx, Ry and optionally Rz movement may be allowed. Movement other than such tilting/rotation (i.e. Tx, Ty and Tx movement) may be constrained or prevented. Examples of actuator assemblies in which such tilting movement is allowed are disclosed in WO 2010/029316 A1 and WO 2011/104518 A1, each of which is herein incorporated by reference.

In yet other specific embodiments, the movable part 20 may be supported in a manner allowing three dimensional translational movement. Optionally, rotational movement about three orthogonal axes may additionally be allowed. The movable part 20 may be suspended entirely by actuating units 30, for example, to allow such movement. Examples of actuator assemblies in which such three dimensional translational movement is allowed are disclosed WO 2011/104518 A1, which is herein incorporated by reference.

The movable part 20 may, alternatively or additionally, move in other DOFs. The movable part 20 may move in DOFs that are a combination of any two or more of Tx, Ty, Tx, Rx, Ry and Rz. For example, the movable part 20 may move along a helical path (i.e. move helically) about the primary axis P, and so concurrently move along the primary axis P and rotate about the primary axis P. Tz and Rz movement may be coupled. An example of such helical movement is described, for example, in WO 2019/243849 A1, which is herein incorporated by reference.

The support structure 10 is used herein as a reference point to describe movement of the movable part 20. Movement of the movable part 20 described herein is thus relative to the support structure 10, unless explicitly stated otherwise. When the actuator assembly 2 is included in an apparatus or device, such as a camera, smartphone, a drone, the support structure 10 may be fixed relative to a main body of the apparatus or device. However, in general the support structure 10 need not necessarily be stationary and may be movable relative to or within such a device. In some embodiments, the movable part 20 may be fixed relative to a main body of the device. Furthermore, although the support structure 10 is schematically depicted as one part in FIG. 1A, in practice the support structure 10 may be formed from a plurality of layers, parts and components that are fixed relative to one another. Similarly, the movable part 20 may be formed from a plurality of layers, parts and components that are fixed relative to one another.

The actuator assembly 2 comprises the actuating units 30. The actuating units 30 are connected between the support structure 10 and the movable part 20. The actuating units 30 are arranged to apply actuating forces F between the movable part 20 and the support structure 10. Selectively applying and varying the actuating forces F may move the movable part 20 relative to the support structure 10, for example within the DOFs allowed by the bearing arrangement 40. The actuating units 30 are thus capable, on selective actuation, of driving movement of the movable part 20 relative to the support structure 10.

The camera apparatus 1 further comprises a lens assembly 3 and an image sensor 4. The lens assembly 3 comprises one or more lenses configured to focus an image on the image sensor 4. The lens assembly 3 defines an optical axis O, which is aligned with the primary axis P in FIG. 1A. The image sensor 4 captures an image and may be of any suitable type, for example a charge coupled device (CCD) or a CMOS device. The lens assembly 3 comprises a lens carrier, for example in the form of a cylindrical body, supporting the one or more lenses. The one or more lenses may be fixed in the lens carrier, or may be supported in the lens carrier in a manner in which at least one lens is movable along the optical axis O, for example to provide zoom or focus, such as auto-focus (AF). The lens carrier itself may be movable along the optical axis O. The lenses or the lens carrier may be moved by a voice coil motor (VCM) or an arrangement of SMA wires (not shown), for example. The apparatus 1 may be a miniature camera apparatus in which the or each lens of the lens assembly 3 has a diameter of 20 mm or less, for example of 12 mm or less.

In the embodiment shown in FIG. 1, the movable part 20 may be considered to comprise the image sensor 4. The lens assembly 3 may be fixed relative to the support structure 10, i.e. mounted on the support structure 10. In other embodiments (not shown), the image sensor 4 may be fixed relative to the support structure 10 and the movable part 20 may comprise the lens assembly 3. In either embodiment, in operation the lens assembly 3 is moved relative to the image sensor 4. Moving the lens assembly 3 laterally (i.e. perpendicularly to the optical axis O) has the effect that the image on the image sensor 4 is moved. So, optical image stabilization (OIS) may be implemented in the apparatus 1. Moving the lens assembly 3 along the optical axis O has the effect of adjusting the focus of the image on the image sensor 4. So, auto-focus (AF) or zoom functionality may be implemented by the apparatus 1.

In yet other embodiments (not shown), a camera module may be fixed relative to the movable part 20. The camera module may comprise the lens assembly 3 and image sensor 4. Tilting the camera module about axes that are orthogonal to the primary axis P and/or rotating the camera module about the primary axis P has the effect that the image on the image sensor 4 is moved. So, optical image stabilization (OIS) may be implemented in the apparatus 1.

The camera apparatus 1 further comprises a controller 8. The controller 8 may be implemented in an integrated circuit (IC) chip. The controller 8 generates drive signals for the actuating units 30, in particular for SMA wires 34 forming part of the actuating units 30. SMA material has the property that on heating it undergoes a solid-state phase change that causes the SMA material to contract. Thus, applying drive signals to the SMA wires 34, thereby heating the SMA wires 34 by allowing an electric current to flow, will cause the SMA wires 34 to contract and thus actuate the actuating unit 30 so as to move the movable part 20. The drive signals are chosen to drive movement of the movable part 20 in a desired manner, for example so as to achieve OIS by stabilizing the image sensed by the image sensor 4 or to achieve AF/zoom by adjusting the focus of the image sensed by the image sensor 4. The controller 8 supplies the generated drive signals to the SMA wires 34.

Optionally, the camera apparatus comprises an inertial measurement unit 6. The inertial measurement unit 6 may comprise one or more vibration sensors, such as gyroscopes, accelerometers or magnetometers, although in general other types of sensors could be used. The inertial measurement unit 6 detects changes in the orientation of and/or the forces on the camera apparatus 1 and generates sensor signals representative of the orientation of and/or forces on the camera apparatus 1. The controller 8 receives the sensor signals and generates the drive signals for the SMA wires 34 in response to the sensor signals, for example so as to counteract the changes in orientation and/or forces represented by the output signals. The controller 8 may thus control the SMA wires 34 to achieve OIS.

Although the actuator assembly 2 is described in connection with the camera apparatus 1, it will be appreciated that the actuator assembly 2 may be used in other applications. So, the lens assembly 3, image sensor 4 and inertial measurement unit 6 need not be affixed to or provided in combination with the actuator assembly 2. The actuator assembly 2 may be used in any device in which movement of a movable part 20 relative to a support structure 10 is desired, including and without limitation to provide haptic feedback in a haptic feedback device or to move a projector or display in an augmented reality (AR) or virtual reality (VR) device.

### Actuating Unit

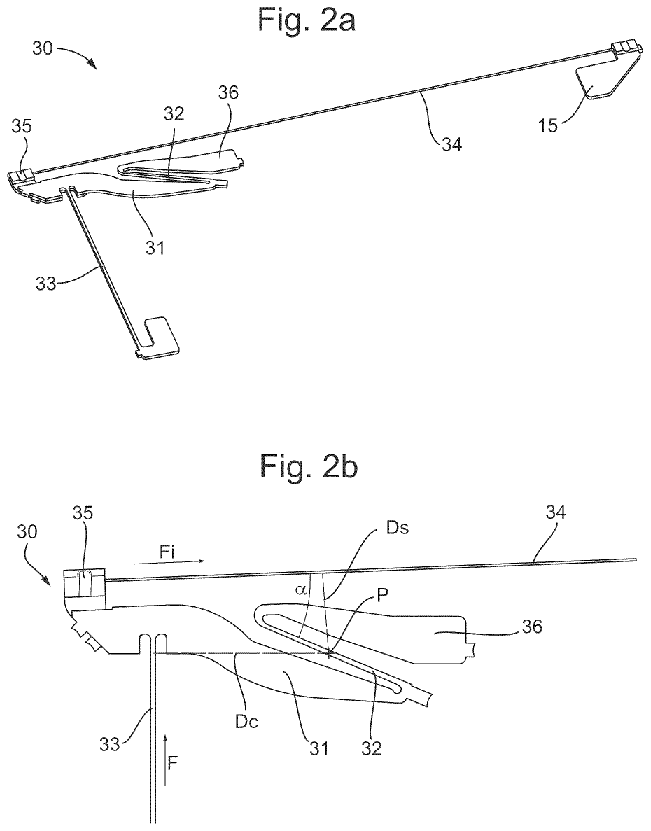

FIG. 2A shows a perspective view of an embodiment of the actuating unit 30. FIG. 2B shows part of the actuating unit 30 in plan view.

One actuating unit 30 is shown in FIGS. 2A and 2B, but it will be appreciated that the actuator assembly 2 may have multiple actuating units 30, each of which may comprise the same components described with reference to FIGS. 2A and 2B. The actuating units 30 may be substantially identical, i.e. the structure and components of the actuating units 30 may be the same, but the actuating units' arrangement relative to the support structure 10 and/or movable part 20 may differ.

The actuating unit 30 comprises a body portion 31. The body portion 31 is a substantially rigid part and is designed not to deform (compared to the force-modifying flexure 32) on actuation of the actuating unit 30. The body portion 31 may be formed from a single layer of material, or may comprise plural parts (e.g. plural layers of material) that are fixed relative to one another.

The actuating unit 30 further comprises a force-modifying flexure 32. The force-modifying flexure 32 is connected between the body portion 31 and the support structure 10. One end of the force-modifying flexure 32 is connected to the body portion 31. The other end of the force-modifying flexure 32 is connected to the support structure 10, in particular via a foot portion 36. The foot portion 36 is fixed relative to the support structure 10. In the depicted design, the force-modifying flexure is formed integrally with the foot portion 36 and with the body portion 31, for example from a single sheet of material (such as metal). The force-modifying flexure 32 may, on flexing, allow the body portion 31 to move relative to the support structure 10 in a direction that is substantially orthogonal to the force-modifying flexure 32. The force-modifying flexure 32 effectively allows the body portion 31 to pivot relative to the support structure 10, with an effective pivot point P provided in a region along the force-modifying flexure 32. The force-modifying flexure 32 thus provides the effective pivot point P. Although the effective pivot point P is depicted in the middle of force-modifying flexure 32 in FIG. 2B, in practice the effective pivot point P need not lie on the force-modifying flexure 32.

The actuating unit 30 further comprises an SMA element 34. In the depicted embodiment, the SMA element 34 is formed as an SMA wire 34. The SMA wire 34 is connected between the body portion 31 and the support structure 10. One end of the SMA wire 34 is connected to the support structure 10, in particular by a respective crimp 15. The other end of the SMA wire 34 is connected to the body portion 31, in particular by a respective crimp 35.

The actuating unit 30 further comprises a coupling link 33. In the depicted embodiment, the coupling link is a coupling flexure 33. The coupling flexure 33 is connected between the body portion 31 and the movable part 20. One end of the coupling flexure 33 is connected to the body portion 31. The other end of the coupling flexure 33 is connected to the movable part 20. The coupling link 33 transfers or transmits an actuating force F from the body portion 31 to the movable part 20. The coupling link 33 is compliant (i.e. deformable) in a direction perpendicular to the actuating force F. This allows the movable part 20 to move in a direction perpendicular to the actuating force F, and in a direction perpendicular to the coupling flexure 33, for example due to actuation of a different actuation unit 30.

The SMA wire 34 is arranged, on contraction, to apply an input force Fi on the body portion 31. The input force Fi acts parallel to the length of the SMA wire 34. The force-modifying flexure 32 is arranged to modify the input force Fi so as to cause the coupling flexure 33 to apply the actuating force F to the movable part 20. In particular, the force-modifying flexure 32 may modify the direction and/or the magnitude of the input force Fi so as to give rise to the actuating force F.

In particular, the input force Fi is capable of deforming the force-modifying flexure 32, thereby moving the body portion 31 about the effective pivot point P. In the depicted embodiment the force-modifying flexure 32 is placed in tension on contraction of the SMA wire 34. The force-modifying flexure 32 is arranged at an angle a relative to the SMA wire 34. As a result, the body portion 31 is arranged, on SMA wire contraction and on resulting deformation of the force-modifying flexure 32, to move at an angle (of about 90 degrees minus α) relative to the length of the SMA wire 34. The force-modifying flexure 32 thus converts the input force Fi, in particular the magnitude and direction thereof, into the actuating force F. The change in magnitude of the force is dependent on (and indeed proportional to) the ratio of i) the (shortest) distance Ds of the SMA wire 34 from the effective pivot point P and ii) the (shortest) distance Dc of the coupling flexure 33 from the effective pivot point P. So, F/Fi is proportional to Ds/Dc. The change in direction of the force results from the angle between SMA wire 34 and coupling flexure 33.

The ratio Ds/Dc is dependent, in part, on the angle a between the SMA wire 34 and the force-modifying flexure 32. The ratio Ds/Dc is further dependent on the location of the end of the SMA wire 34 that is connected to the body portion 31 and the location of the end of the coupling flexure 33 that is connected to the body portion 31. By way of example, the distance Ds could be increased by connecting the coupling flexure further to the left of body portion 31 in FIG. 2B, thereby increasing the ratio Ds/Dc and so the degree of force amplification. In general, the amount by which the force-modifying flexure 32 amplifies or de-amplifies the force/stroke of the SMA wire 32 may be tailored by:
adjusting the angle a between SMA wire 34 (and thus in particular between the input force Fi) and the force-modifying flexure 32;
adjusting the location of the connection point between the SMA wire 32 and the body portion 31 (and thus in particular the location at which the input force Fi acts on the body portion 31);
adjusting the angle between the coupling flexure 33 (and thus in particular between the actuating force F) and the force-modifying flexure 32; and
adjusting the location of the connection point between the coupling flexure 33 and the body portion 31 (and thus in particular the location from which the body portion applies the actuating force Fi).

If the SMA wire 34 is closer to the effective pivot point P than the coupling flexure 33, then the input force Fi applied on contraction of the SMA wire 32 is de-amplified. At the same time, the movement of the movable part 20 is amplified relative to a change in length of the SMA wire 34. Alternatively, if the SMA wire 34 is further away from the effective pivot point P than the coupling flexure 33, then the input force Fi applied on contraction of the SMA wire 32 is amplified. At the same time, the movement of the movable part 20 is de-amplified relative to a change in length of the SMA wire 32. The actuating unit 30 can thus be configured to amplify movement or to amplify force due to contraction of the SMA wire 34. In some embodiments, the actuating unit 30 is configured to change the direction of the input force Fi so as to give rise to the actuating force F, without changing the magnitude of the force or movement.

In some embodiments, at least one actuating unit 30, preferably each actuating unit 30, is configured such that the force-modifying flexure 32 amplifies an amount of contraction of the SMA wire 34 to a relatively greater amount of movement of the movable part 20 relative to the support structure 10. Such amplification, for example, may be by a factor greater than 1.5, preferably greater than 2, further preferably greater than 3.

For this purpose, the angle α between the SMA wire 34 and the force-modifying flexure 32 may be in the range from 0 to 45 degrees, preferably from 13 to 40 degrees. However, in general, the angle α may have other values and the connection points of the SMA wire 32 and/or coupling flexure 33 to the body portion 31 may be adjusted to achieve a desired amount of amplification.

In some other embodiments, at least one actuating unit 30, preferably each actuating unit 30, is configured such that the force-modifying flexure 32 amplifies a magnitude of the input force Fi applied by the SMA wire 34 to a relatively greater magnitude of the actuating force F acting on of the movable part 20. Such amplification, for example, may be by a factor greater than 1.5, preferably greater than 2, further preferably greater than 3.

For this purpose, the angle a between the SMA wire 34 and the force-modifying flexure 32 may be in the range from 45 to 90 degrees, preferably from 77 to 50 degrees. However, in general, the angle a may have other values and the connection points of the SMA wire 32 and/or coupling flexure 33 to the body portion 31 may be adjusted to achieve a desired amount of amplification.

In the depicted embodiment, the coupling flexure 33 is at an angle of substantially 90 degrees relative to the SMA wire 34. This allows the actuating unit 30 to fold around a corner of the movable part 20 in a compact manner. The angle between the coupling flexure 33 and the SMA wire 34 may be in the range from 70 to 110 degrees, preferably from 80 to 100 degrees. However, in general, the angle between coupling flexure 33 and SMA wire 34 may be outside these ranges.

In the depicted embodiment, the actuating unit 30 is arranged in a plane. In particular, the SMA wire 34, the coupling flexure 33 and the force-modifying flexure 32 are arranged substantially to extend in a common plane. This allows for a compact configuration of the actuating unit 30. The body portion 31, when embodied by a plate, may further be arranged to extend in the plane. However, in general, the components of the actuating unit 30 need not be arranged in a common plane. The SMA wire 32 and/or the coupling flexure 33 may be angled relative to the plane, for example.

In the above-described embodiments, the force-modifying flexure 32 is placed in tension on contraction of the SMA wire 34. This reduces the risk of buckling of the force-modifying flexure 32, reducing the risk of damage to the actuator assembly and making the actuator assembly 2 more reliable. However, in general, the force-modifying flexure 32 could also be arranged so as to be placed under compression on contraction of the SMA wire 34. With reference to FIG. 2B, for example, the force-modifying flexure 32 could extend to the bottom-right from the connection point between the body portion 31 and the force-modifying flexure 32, and so be placed under compression on contraction of the SMA wire 34. An arrangement in which the force-modifying flexure 32 is placed under compression is disclosed in WO 2022/084699 A1, which is herein incorporated by reference.

In the above-described embodiments, the force-modifying flexure 32 and the SMA wire 34 connect at one end to the support structure 10, and the coupling flexure 33 connects at one end to the movable part 20. In general, this arrangement may also be reversed, with the force-modifying flexure 32 and the SMA wire 34 connecting at one end to the movable part 20, and the coupling flexure 33 connecting at one end to the support structure 10.

In the above-described embodiments, the actuating unit 30 comprises a coupling link 33 in the form of a coupling flexure 33. The purpose of the coupling link 33 is to allow movement of the movable part 20 in directions orthogonal to the actuating force F. In general, however, the actuating unit 33 need not comprise a coupling link 33, for example in embodiments in which there is no movement of the movable part 20 in directions orthogonal to the actuating force F. Furthermore, the coupling link 33 may be embodied by components other than the coupling flexure 33, for example by a ball bearing or plain bearing configured to transmit the actuating force F to the movable part 20 while allowing movement of the movable part 20 in directions orthogonal to the actuating force F. Such alternative embodiments of the coupling link 33 are disclosed in WO 2022/084699 A1, which is herein incorporated by reference.

### Arrangement of Four Actuating Units

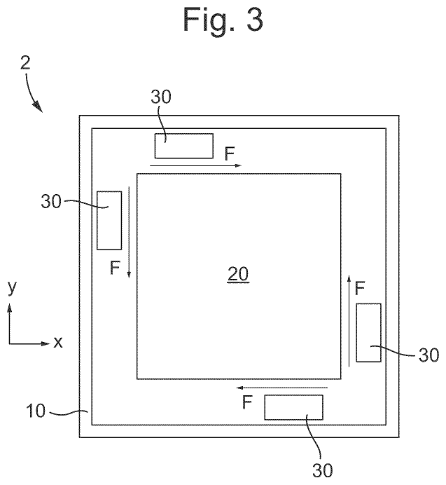

FIG. 3 schematically depicts a plan view of an embodiment of the actuator assembly 2, showing an arrangement of actuating units 30. In the depicted embodiment, the actuator assembly 2 comprises a total of four actuating units 30. The four actuating units 30 may apply actuating forces F between the movable part 20 and the support structure 10. The actuating forces F are applied to the movable part 20 relative to the support structure 10.

The arrangement of actuating units 30 of FIG. 3 may be used, for example, in embodiments in which the movable part 20 is movable relative to the support structure 10 in a movement plane. So, Tx, Ty and optionally Rz movement of the movable part 20 may be allowed.

The four actuating units 30 of FIG. 3 are in an arrangement capable of applying actuating forces F so as to move the movable part 20 relative to the support structure 10 to any positions within a range of movement. The range of movement may be within a movement plane that is perpendicular to the primary axis P.

In particular, two actuating units 30 (e.g. the top and bottom actuating units in FIG. 3) are arranged to apply actuating forces F in opposite directions parallel to a first axis (e.g. the x axis in FIG. 3). The other two of actuating units (e.g. the left and right actuating units in FIG. 3) are arranged to apply actuating forces F opposite directions parallel to a second axis (e.g. the y axis in FIG. 3), orthogonal to the first axis. By appropriately varying the difference in actuation amount between the opposing actuating units 30, the movable part 20 may thus be moved independently along the first and second axes. The opposing actuating forces F are not colinear, but offset from each other in a direction perpendicular to the actuating forces. Providing opposing actuating units 30 allows the tension in the SMA wires 30 of the respective actuating units 30 to be controlled, allowing for more accurate and reliable positioning of the movable part 20 compared to a situation in which actuating units 30 do not oppose each other.

In embodiments, none of the actuating forces F are collinear. This allows the arrangement of actuating units 30 to translationally move the movable part 20 without applying any net torque to the movable part 20. So, the movable part 20 can be moved translationally in the movement plane without rotating the movable part 20 in the movement plane. In general, the arrangement of actuating units 30 is capable of accurately controlling a torque or moment of the movable part 20 about the primary axis P. So, the actuating units 30 are capable of rotating (or not rotating) the movable part 20 relative to the support structure about the primary axis P.

In particular, two actuating units 30 (e.g. the top and bottom actuating units in FIG. 3) are arranged to apply actuating forces F so as to generate a torque or moment between the movable part 20 and the support structure 2 in a first sense (e.g. clockwise) around the primary axis P. The other two actuating units 30 (e.g. the left and right actuating units 30 in FIG. 3) are arranged to apply actuating forces F so as to generate a torque or moment between the movable part 20 and the support structure 2 in a second, opposite sense (e.g. anti-clockwise) around the primary axis P. This allows the movable part 20 to be rotated by simultaneously increasing or decreasing the tension of SMA wires in any of the two actuating units 30.

As shown, two actuating units 30 may be arranged to apply actuating forces in a corner of the actuator assembly 2. The other two actuating units 30 may be arranged to apply actuating forces in another, opposite corner of the actuator assembly 2. The actuator assembly 2, and in particular the movable part 20 and/or the support structure 10, may have a square or rectangular footprint. Each actuating unit 30 may be provided on one of the four sides of the actuator assembly 2. In particular, each actuating unit 30 may bend around a corner of the movable part 20 such that the SMA wire 32 and the coupling flexure 33 of each actuating unit 30 extend along adjacent edges of the movable part 20. So, the actuating unit 30 may be as configured in FIGS. 2A and 2B, for example. The four SMA wires 32 of the four actuating units 32 may extend along the four different edges of the movable part 20.

The arrangement of actuating forces F applied between movable part 20 and support structure 10 corresponds to the arrangement of SMA wires 30 described in WO2013/175197 A1, which is herein incorporated by reference.

In the depicted embodiment, the actuating forces Fare perpendicular to the primary axis P, and may be parallel to the movement plane. However, in general the actuating forces F may be angled relative to the movement plane. The actuating forces F may thus have a component along the primary axis P. This component along the primary axis P may be resisted by the bearing arrangement 40, for example, to provide movement of the movable part 20 in degrees of freedom allowed by the bearing arrangement 40. In some embodiment it may even be desirable for actuating forces F to have a component in parallel to the primary axis P, for example so as to load plain or rolling bearings arranged between the movable part 20 and the support structure 10.

Although, for illustrative purposes, the arrangement of actuating units 30 was described as moving the movable part 20 in the movement plane (e.g. translationally along the x and y axis, or rotationally about the primary axis P), in other embodiments the movable part 20 may be moved differently. For example, the same arrangement of actuating forces F may be used to tilt the movable part 20 relative to the support structure 10 about axes orthogonal to the primary axis, due to appropriate movement constraints provided by the bearing arrangement 40. For example, the bearing arrangement 40 may comprise a plurality of flexures for guiding tilting of the movable part 20 about the axes orthogonal to the primary axis P. Examples of such bearing arrangement 40 are described in WO2022/029441 A1, which is herein incorporated by reference.

Although the actuator assembly 2 is described herein in the context of four actuating units 30, in general the actuator assembly 2 may comprise fewer actuating units 30. For example, the actuator assembly 2 may comprise two actuating units 30, e.g. the two actuating units 30 depicted in the top left of FIG. 3. The forces applied to the movable part 20 by the two actuating units 30 may be opposed by a biasing force of one or more resilient elements, such as springs. With reference to FIG. 3, the two actuating units 30 in the bottom right corner may be replaced with springs applying biasing forces along the corresponding depicted arrows, for example.

### Endstops for Actuating Unit

In conventional SMA actuator assemblies, endstops may be provided between the movable part 20 and the support structure 10. These endstops are formed from an endstop surface on the movable part 20 and a corresponding endstop surface on the support structure 10. The endstops are configured to engage upon movement of the movable part 20 relative to the support structure 10 that is outside the desired degrees of freedom of movement, i.e. movement of the movable part 20 relative to the support structure 10 that is not due actuation of the actuating units. Such movement may happen, for example, due to impact events such as drops.

The endstops may be the arranged so as to engage first, i.e. before any other portions of the movable part 20 and support structure 10 engage. The endstops are designed to prevent or reduce the risk of damage to the SMA wire or other components of the actuator assembly due to impact events.

The inventors of the present invention have realized that endstops in conventional actuator assemblies, i.e. endstops between the movable part 20 and the support structure 10, may not be sufficient to prevent or reduce the risk of damage to SMA wires 34 when actuating units 30 are provided. This is because the body portion 31 of the actuating unit 30 may move even when an endstop between the movable part 20 and the support structure 10 engages. Such movement of the body portion 31 may lead to over-straining and thus damage of the SMA wire 34.

The present invention thus relates to providing one or more endstops 50 to the actuating unit 30. In particular, an endstop 50 between the actuating unit 30 and the support structure 10 may be provided. The actuating unit 30 (for example the body portion 31) may be provided with an endstop surface 50m, and the support structure 10 may be provided with a corresponding endstop surface 50s.

The endstop 50 engages, i.e. the endstop surfaces 50m, 50s engage, upon movement of the body portion 31 that is not due to actuation of the actuating units 30. The body portion 31 is arranged, upon actuation of one or more actuating units 30 of the actuator assembly 2, to move along a path in an actuating plane within a range of expected movement. The endstop 50 is configured to engage upon movement of the body portion 31 in the actuating plane beyond the range of expected movement.

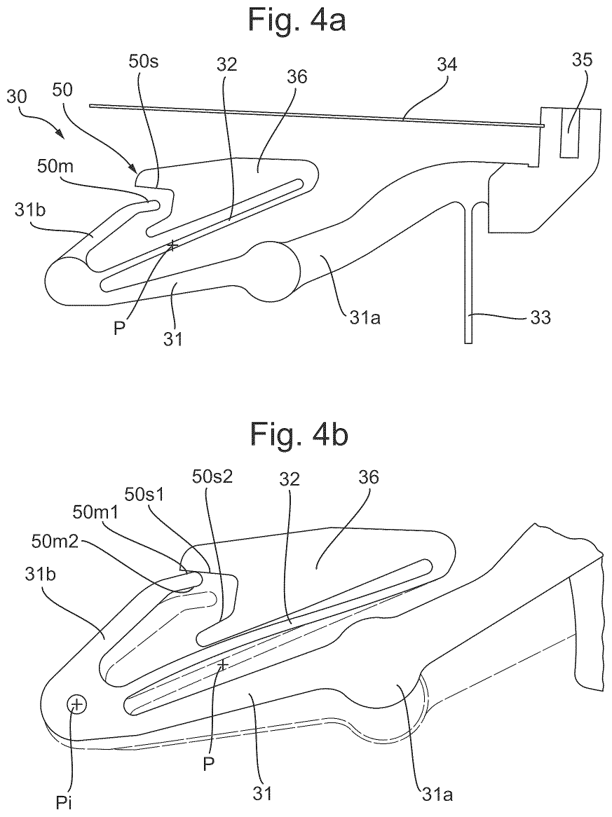

FIG. 4a schematically depicts, in plan view, an endstop 50 to an actuating unit 30. In FIG. 4a, the actuating plane is the plane of the drawing.

The endstop 50 comprises an endstop surface 50m on the body portion 31, and an endstop surface 50s on the support structure 10. In the embodiment of FIG. 4a, the body portion 31 comprises two arms 31a, 31b, in particular a first arm 31a and a second arm 31b. The two arms 31a, 31b are rigidly connected to one others, and may be integrally formed from the same material. The two arms 31a, 31b may be formed from the same layer, or be formed by different layers. Locating the endstop 50 on an arm 31b that is different to the arm 31b to which the SMA element 34 connects may allow the endstop 50 to be positioned without affecting the structure of the amplifying mechanism.

The first arm 31a extends between the force-modifying flexure 32 and the SMA element 34. In particular, the first arm 31a extends from a connection point of the force-modifying flexure 32 to the body portion 31 to a connection point (e.g. the connection element 35) of the SMA element 34 to the body portion 31. The second arm 31b extends from a connection point of the force-modifying flexure 32 to the body portion 31 to the endstop 50, i.e. to the endstop surface 50m on the body portion 50.

The first and second arms 31a, 31b extend to different sides of the force-modifying flexure 32 when viewed perpendicularly to the actuating plane. The arms 31a, 31b branch in different directions from the connection to the force-modifying flexure 32. In FIG. 4a, for example, the first arm 31a extends below the force-modifying flexure 32 and the second arm 31b extends above the force-modifying flexure 32.

As shown in FIG. 4a, the first arm 31a may be longer than the second arm 31b. For example, the ratio of the length of the first arm 31a from the force-modifying flexure 32 to the length of the second arm 31 b from the force-modifying flexure 32 may greater than 1, in particular greater than 1.5 or greater than 2. This may contribute to smaller movement at the endstop 50 compared to the stroke of the SMA element 34. Effectively, movement of the endstop surface 50m on the body portion 31 may be geared down compared to the movement of the end of the SMA element 34 connected to the body portion 31. This is because the endstop 50 may be arranged to be closer to the effective pivot point P than the connection point between the body portion 31 and the SMA element 34. The clearance between the endstop surfaces 50a, 50b may thus be reduced, resulting in a more reliable endstop enabling a reduced risk of damage to the SMA element 34 compared to a situation in which the clearance is large.

As also shown in FIG. 4a, the endstop 50 is located relative to the force-modifying flexure 32 in a direction that is orthogonal to the length of the force-modifying flexure 32 when viewed perpendicularly to the actuating plane. So, the endstop 50 is arranged transverse to the force-modifying flexure 32, rather than in a longitudinal direction to the force-modifying flexure 32, in contrast to the embodiments of FIGS. 7a-c, for example. The endstop 50 is located, in particularly entirely located, within an area between i) a first line that is perpendicular to the length of the force-modifying flexure 32 and intersecting the connection point between the force-modifying flexure 32 and the body portion 31 and ii) a second line that is perpendicular to the length of the force-modifying flexure 32 and intersecting the connection point between the force-modifying flexure 32 and the support structure 10 (in particular the foot-portion 36 which may be considered to be part of the support structure 10).

Arranging the endstop 50 in this location is beneficial because it stops excessive deformation of the force-modifying flexure 32 in a direction orthogonal to its extent. The force-modifying flexure 31 may carry relatively large loads along its length, but be deformable by relatively small loads in directions orthogonal to its length. As such, endstops 50 limiting deformation of the force-modifying flexure 31 in a direction orthogonal to its length are particularly desirable.

The endstop 50 may further be positioned, when viewed perpendicularly to the actuating plane, within a particular angle about the effective pivot point P. The angle may have a value from 0 to 60 degrees, preferably from 0 to 45 degrees or from 0 to 30 degrees, from a line that is perpendicular to the length of the force-modifying flexure 32 and goes through the effective pivot point P. In particularly preferably embodiments, the endstop 50 is arranged along the line that is perpendicular to the length of the force-modifying flexure 32 and goes through the effective pivot point P. The length of the force-modifying flexure 32 in this context is the length in a non-deformed state of the force-modifying flexure 32.

FIG. 4b shows the endstop 50 of the actuating unit 30 of FIG. 4a engaging, for example as a result of an impulse (e.g due to an impact event, such as a drop) acting on the actuator assembly 2 in the downwards direction. Such an impulse may cause the body portion 31 to move in the actuating plane beyond the range of expected movement. As a result, the endstop 50 engages. The body portion 31 may effectively be considered to pivot about an impulse pivot point Pi. The endstop 50 may be arranged to be closer to the effective pivot point P than to the impulse pivot point Pi. As a result, the clearance between the endstop surfaces 50s, 50m varies significantly, allowing the endstop 50 to engage, compared to normal operation of the actuator assembly 2.

FIG. 4 b also shows that there are two endstops 50 provided on the arm 31b. A first endstop 50 is formed between endstop surfaces 50m1, 50s1. A second endstop 50 is formed between endstop surfaces 50m2, 50s2. The first endstop 50 engages upon movement of the body portion in a first direction (upwards in FIG. 4b), and the second endstop 50 engages upon movement of the body portion in a second direction that is opposite to the first direction (downwards in FIG. 4b). The first and second directions may be orthogonal to the length of the force-modifying flexure 32. The actuating unit 30 may thus be considered to comprise two opposing endstops 50.

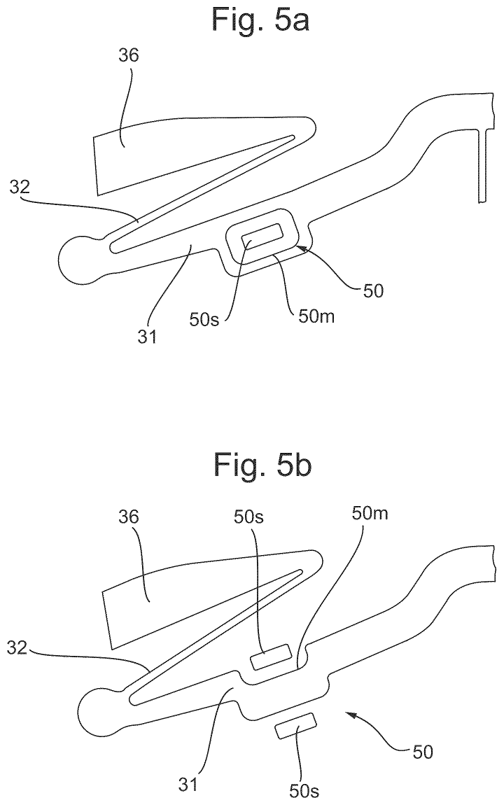

FIGS. 5a and 5b depict alternative embodiments of the endstop 50 provided on the actuating unit 30. In comparison to the actuating unit 30 of FIG. 4, the body portion 31 of the actuating unit 30 of FIG. 5 comprises a single arm on which both the endstop 50 and the connection to the coupling link 33 and SMA element 34 are provided. Otherwise, the endstop 50 is located in a manner similar to that described in connection with the embodiment of FIG. 4. So, the endstop 50 may be located orthogonally to the length of the force-modifying flexure 32, and/or within the described particular angular range relative to the effective pivot point P.

FIG. 5a schematically shows an endstop 50 formed by a slot 50m in the body portion 50 and a corresponding protrusion 50s that is fixed relative to the support structure 10. The protrusion 50s may be considered to form part of the support structure 10. The protrusion 50s is arranged in the slot 50m. The slot 50m surrounds, in particular entirely surrounds, the protrusion 50s. The protrusion 50s (in particular the outer surface thereof when viewed perpendicular to the actuating plane) provides one or more endstop surfaces 50s fixed relative to the support structure 10. The slot 50m (in particular the inner surface thereof when viewed perpendicular to the actuating plane) provides one or more endstop surfaces 50m on the body portion 31 of the actuating unit 30. During normal operation, the protrusion 50s is configured to move within the slot 50m, without engaging the surfaces of the slot 50m. The protrusion 50s may engage with the surfaces of the slot 50m due to an impulse acting on the actuator assembly 2.

Although the endstop 50 of FIG. 5a is schematically depicted as a slot 50m in the body portion 31 and a protrusion 50s of the support structure 10, it will be appreciated that equally a slot 50s could be formed in the support structure 10 and a corresponding protrusion 50m could be provided on the body portion 31.

FIG. 5b schematically shows an endstop 50 formed by a portion 50m of the body portion 31 arranged between two protrusions 50s that are fixed relative to the support structure 10. During normal operation, the portion 50m of the body portion 31 is configured to move relative to the protrusions 50s without engagement thereof. The portion 50m of the body portion 31 is configured to engage one of the protrusions 50s due to an impulse acting on the actuator assembly 2.

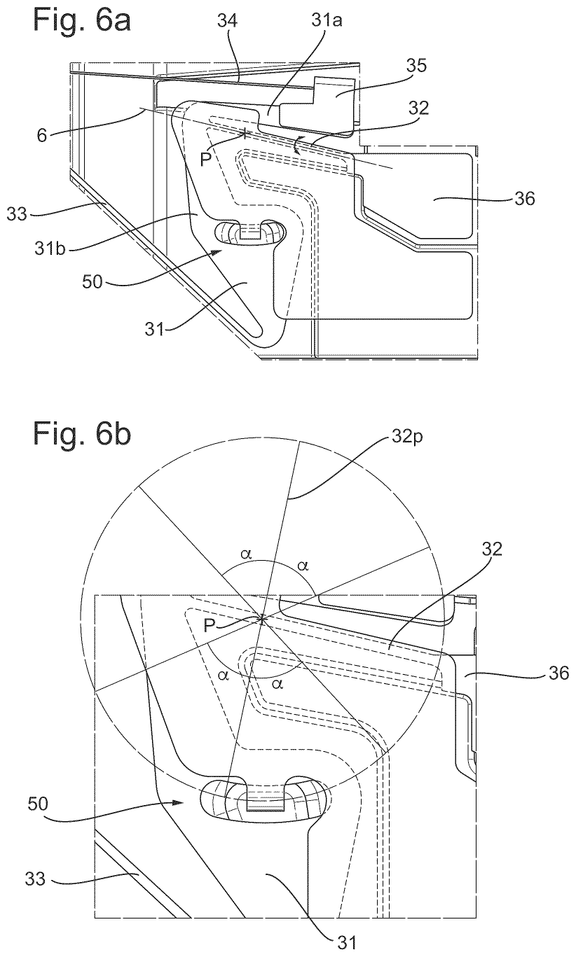

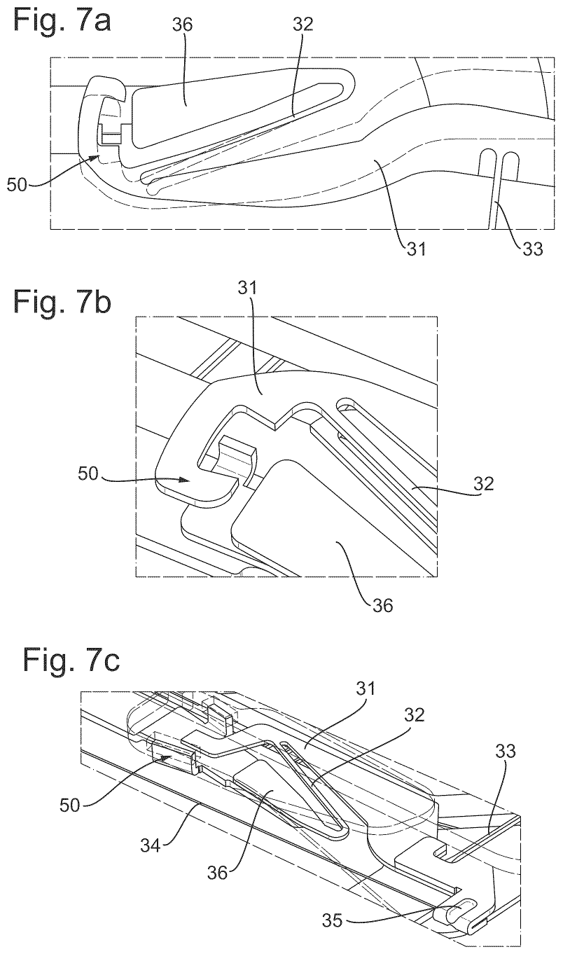

FIGS. 6a and 6b schematically show a further embodiment of the endstop 50 on the actuating unit 30. The endstop 50 is formed by a slot 50m in the body portion 31 and a corresponding protrusion 50s of the support structure 10, similar to the embodiment of FIG. 5a. In the embodiment of FIG. 6, the body portion 31 comprises two arms 31a, 31b. The arms 31a, 31b are similar to those described in relation to the embodiment of FIG. 4a, except that the coupling link 33 is connected to the second arm 31b on which the endstop 50 is also provided.

FIG. 6b shows further details of the arrangement and structure of the endstop 50. As already described in relation to FIG. 4a, the endstop may be arranged in a particular angular range about the effective pivot point P. This angular range is further specified and explained with reference to FIG. 6b, but is generally applicable to endstops 50 of other embodiments described herein.

In particular, when viewed perpendicularly to the actuating plane, the endstop 50 may be provide within an angular range defined by the angle a from a line 32p that is perpendicular to the length of the force-modifying flexure 32 and goes through the effective pivot point P. The angular range (i.e. the angle α) may be from 0 to 60 degrees. Preferably, the angular range is from 0 to 45 degrees.

As also shown in FIG. 4b, the slot 50m may be curved. The slot 50m may be shaped along an arc of a virtual circle about the effective pivot point P. This may allow the clearance of the endstop 50 to remain substantially constant as the body portion 31 moves within the actuating plane. The slot 50m thus forms an elongate path along which the protrusion 50s moves upon actuation of the one or more actuating units 30s. The endstop 50 is configured to engage upon movement of the protrusion 50s relative to the slot 50m in a direction orthogonal to the elongate path, i.e. in the upwards or downwards direction in FIG. 6b.

FIGS. 7a to 7c show further embodiments of the endstop 50 provided on the actuating unit 30. In these Figures, an endstop 50 is formed between a second arm 31b of the body portion 31 and a protrusion of the support structure 31. The protrusion is formed by folding up a sheet of metal formed on the support structure 31. The protrusion may be formed integrally with the foot portion 36. In the embodiments of FIGS. 7a to 7c, the endstop 50 is not arranged orthogonally to the force-modifying flexure 32. Instead, the endstop 50 is formed longitudinally along the length of the force-modifying flexure 32.

### SMA

The above-described SMA actuator assemblies comprise at least one SMA wire, which more generally may be referred to as an SMA element. The term ‘shape memory alloy (SMA)element’ may refer to any element comprising SMA. The SMA element may be described as an SMA wire. The SMA element may have any shape that is suitable for the purposes described herein. The SMA element may be elongate and may have a round cross section or any other shape cross section. The cross section may vary along the length of the SMA element. The SMA element might have a relatively complex shape such as a helical spring. It is also possible that the length of the SMA element (however defined) may be similar to one or more of its other dimensions. The SMA element may be sheet-like, and such a sheet may be planar or non-planar. The SMA element may be pliant or, in other words, flexible. In some examples, when connected in a straight line between two components, the SMA element can apply only a tensile force which urges the two components together. In other examples, the SMA element may be bent around a component and can apply a force to the component as the SMA element tends to straighten under tension. The SMA element may be beam-like or rigid and may be able to apply different (e.g. non-tensile) forces to elements. The SMA element may or may not include material(s) and/or component(s) that are not SMA. For example, the SMA element may comprise a core of SMA and a coating of non-SMA material. Unless the context requires otherwise, the term ‘SMA element’ may refer to any configuration of SMA material acting as a single actuating element which, for example, can be individually controlled to produce a force on an element. For example, the SMA element may comprise two or more portions of SMA material that are arranged mechanically in parallel and/or in series. In some arrangements, the SMA element may be part of a larger SMA element. Such a larger SMA element might comprise two or more parts that are individually controllable, thereby forming two or more SMA elements. The SMA element may comprise an SMA wire, SMA foil, SMA film or any other configuration of SMA material. The SMA element may be manufactured using any suitable method, for example by a method involving drawing, rolling, deposition and/or other forming process(es). The SMA element may exhibit any shape memory effect, e.g. a thermal shape memory effect or a magnetic shape memory effect, and may be controlled in any suitable way, e.g. by Joule heating, another heating technique or by applying a magnetic field.

1. An actuator assembly comprising:
a first part;
a second part that is movable relative to the first part; and
one or more actuating units each configured, on actuation, to apply a respective actuating force to the second part capable of moving the second part relative to the first part, and
wherein each actuating unit comprises:
a body portion arranged, upon actuation of the one or more actuating units, to move along a path in an actuating plane within a range of expected movement;
a force-modifying flexure connected between the body portion and the first part;
an SMA element connected between the body portion and the first part, wherein the SMA element is arranged, on actuation, to apply an input force to the body portion capable of deforming the force-modifying flexure such that the actuating force is applied to the second part;
further comprising at least one endstop between each actuating unit and the first part, wherein the at least one endstop is configured to engage upon movement of the body portion in the actuating plane beyond the range of expected movement.

2. An actuator assembly according to claim 1, wherein the at least one endstop comprises a first endstop surface on the body portion of the respective actuating unit and a second endstop surface fixed relative to the first part, wherein the first and second endstop surfaces are configured to engage upon engagement of the endstop.

3. An actuator assembly according to claim 1, wherein the endstop is located relative to the force-modifying flexure in a direction that is orthogonal to the length of the force-modifying flexure when viewed perpendicularly to the actuating plane.

4. An actuator assembly according to claim 1, wherein the body portion is arranged to move about an effective pivot point provided by the force-modifying flexure, upon actuation of the one or more actuating units, and
wherein, when viewed perpendicularly to the actuating plane, within an angular range from 0 to 60 degrees, preferably from 0 to 45 degrees, from a line that is perpendicular to the length of the force-modifying flexure and goes through the effective pivot point.

5. An actuator assembly according to claim 1, wherein the endstop is formed between by a slot in body portion or in the support structure and a corresponding protrusion in the support structure or body portion, wherein the protrusion is arranged within the slot such that the protrusion is configured to engage with the slot upon movement of the body portion in the actuating plane beyond the range of expected movement.

6. An actuator assembly according to claim 5, wherein the body portion is arranged to move about an effective pivot point provided by the force-modifying flexure, upon actuation of the one or more actuating units, and
wherein the slot is shaped along an arc of a virtual circle about the effective pivot point.

7. (canceled)

8. An actuator assembly according to claim 5, wherein the slot forms an elongate path along which the protrusion is configured to move relative to the slot along upon actuation of the one or more actuating units, and wherein endstop is configured to engage upon movement of the protrusion relative to the slot in a direction orthogonal to the elongate path.

9. An actuator assembly according to claim 1, wherein the body portion comprises a first arm and a second arm, wherein the first arm extends between the force-modifying flexure and the SMA element, and wherein the second arm extends between the force-modifying flexure and the endstop.

10. An actuator assembly according to claim 9, wherein the first and second arms extend to different sides of the force-modifying flexure when viewed perpendicularly to the actuating plane.

11. An actuator assembly according to claim 9, wherein the ratio of the length of the first arm from the force-modifying flexure to the length of the second arm from the force-modifying flexure is greater than 1, in particular greater than 1.5 or greater than 2.

12. An actuator assembly according to claim 1, wherein upon actuation of an actuating unit, the body portion of the actuating unit is configured to pivot about an effective pivot point, wherein the endstop is arranged to be closer to the effective pivot point than the connection point between the body portion and the SMA element.

13. An actuator assembly according to claim 1, wherein the endstop is configured such that the clearance between the first and second endstop surfaces is arranged to vary by less than 20%, preferably less than 10% upon actuation of the respective actuating unit.

14. An actuator assembly according to claim 1, wherein for each actuating unit, the respective endstop is configured to engage when an impulse acts on the actuator assembly causing the body portion to move in the actuating plane beyond the range of expected movement.

15. An actuator assembly according to claim 1, wherein the body portion of the actuating unit is configured, upon an impulse acting on the actuator assembly, to pivot about an impulse pivot point, wherein the endstop is arranged to be closer to the effective pivot point than to the impulse pivot point.

16. An actuator assembly according to claim 1, wherein the clearance between the endstop surfaces of the endstop is in the range from 2% to 20%, preferably from 4% to 10% of the length of the force-modifying flexure.

17. An actuator assembly according to claim 1, comprising at least two endstops between each actuating unit and the first part, wherein one of the at least two endstops is configured to engage upon movement of the body portion in a first direction and wherein the other of the at least two endstops is configured to engage upon movement of the body portion in a second direction that is opposite to the first direction.

18. (canceled)

19. (canceled)

20. An actuator assembly according to claim 1, wherein each actuating unit further comprises a coupling flexure connected between the body portion and the second part, wherein the coupling flexure transmit the actuating force from the body portion to the second part, and wherein the coupling flexure is compliant in a direction perpendicular to the direction of the actuating force.

21. An actuator assembly according to claim 20, wherein the connection point between the coupling flexure and the body portion is closer to the connection point between the SMA element and the body portion than to the connection point between the force-modifying flexure and the body portion.

22. (canceled)

23. An actuator assembly according to claim 1, comprising four actuating units arranged so as to be capable of moving the second part relative to the first part in any direction in a movement plane without applying any net torque to the second part about a primary axis perpendicular to the movement plane, wherein a first pair of actuating units are each configured to apply a torque to the second part in one sense about the primary axis, and a second pair of actuating units are each configured to apply a torque to the second part in the other sense about the primary axis.

24. (canceled)

25. An actuator assembly according to claim 1, comprising a lens assembly that is fixed relative to the first or second part, the lens assembly having an optical axis that is perpendicular to the movement plane, and further comprising an image sensor that is fixed relative to the other of the first or second part, the image sensor having a photo-sensitive surface that is parallel to the movement plane.
